(19) United States
(12) Patent Application Publication
(10) Pub. No.: US 2026/0029331 A1
(43) Pub. Date: Jan. 29, 2026

(54) IMAGING ELLIPSOMETER FOR AREAL LAYER THICKNESS MEASUREMENT OF A SAMPLE AND METHOD USING AN IMAGING ELLIPSOMETER

(71) Applicant: TECHNISCHE UNIVERSITAET WIEN, Wien (AT)

(72) Inventors: Ferdinand BAMMER, Wien (AT); Florian Ferdinand HUEMER, Wien (AT)

(21) Appl. No.: 18/996,477

(22) PCT Filed: Jul. 21, 2023
(86) PCT No.: PCT/EP2023/070306

§ 371 Date: Jan. 17, 2025

(30) Foreign Application Priority Data
Jul. 22, 2022 (DE) 10 2022 118 379.3

(51) Int. Cl. G01N 21/21; G01B 11/06

(52) U.S. Cl. CPC G01N 21/211; G01B 11/0641

(57) ABSTRACT

An imaging ellipsometer is provided for the areal measurement of the layer thickness of a preferably cylindrical sample, including a monochromatic light source configured to shine light onto the sample, a polarizer configured to polarize the light emitted by the light source, an angle-selective lens, and a polarization camera. The polarization camera has polarization filters in 0°, 45°, 90° and 135° orientations and is adapted to polarize the light emitted by the light source into linear polarization orientations and to detect and measure their respective light intensities. A quarter-wave plate is disposed between the sample and the polarization camera in order to change polarization of the light. The quarter-wave plate is adapted to convert certain linear polarization orientations of the light into circular polarization orientations and the ellipsometer is adapted to calculate a layer-thickness-dependent ratio of the detected light intensities. Furthermore, a method is provided for using an imaging ellipsometer.

### BACKGROUND

The present invention relates to an imaging ellipsometer for measuring the layer thickness of a sample over an area according to the generic term of claim 1 and a method using such an imaging ellipsometer according to claim 5.

From the prior art imaging measurement systems are known, inter alia for measuring the layer thickness of samples. Documents U.S. Pat. No. 5,963,326 A and US 2014 0 204 203 A1 describe imaging measuring processes on large samples using a collimated light beam. The light beams are detected using afocal optics and the actual polarization measurement is carried out by a polarizer, also known as an analyzer in ellipsometry. Furthermore, document U.S. Pat. No. 4,516,855 A describes a method for determining a polarization state using a converted TV camera. The measurement system uses three different cameras, each with a polarizer in front of it at angles of 0°, 60° and 120°. U.S. Pat. No. 7,768,660 B1 describes a system for measuring samples on their inside of the glass with separate detection of the external and internal reflection. The sample is measured pointwise. Conventional measuring systems are limited to complex laboratory measurement technology (in particular spectroscopy), which makes the components expensive and elaborate, generates unnecessarily high amounts of data, requires a long measuring time due to the time-consuming punctiform measuring processes, and usually does not offer a complete surface measurement. In addition, the differences in camera sensitivities and fluctuations result in an inaccurate (measurement) system.

### SUMMARY

In contrast, the present invention is based on the object of avoiding or at least mitigating the disadvantages from the prior art and, in particular, further developing an imaging ellipsometer as a compact measurement system for areal layer thickness measurement of a sample, in which, on the one hand, the measuring speed is to be improved and, on the other hand, the complexity and costs of the system are to be kept low. Furthermore, a (measuring) method with such an imaging ellipsometer is to be provided, which can be carried out in real time and without contact.

In a generic ellipsometer, this task is solved by equipping the ellipsometer as a measuring system for areal layer thickness measurement of a sample with a polarization camera that in turn has polarization filters in 0°, 45°, 90° and 135° alignment, i.e. the polarization axes of these filters are rotated by the respective angles.

Accordingly, the invention relates to an imaging ellipsometer for areal measurement of the layer thickness of a preferably cylindrical sample, with a monochromatic light source configured to irradiate/shine light to the sample, a polarizer that is configured to linearly polarize the light emitted by the light source, an angle-selective lens, the light reflected by the sample passes through the angle-selective lens, and a polarization camera, onto which the light reflected by the sample strikes. The polarization camera has polarization filters/polarization layers in 0°, 45°, 90° and 135° alignments/positions and is configured to polarize the light emitted by the light source into linear polarization orientations/polarization directions and to detect and measure their light intensities. In so doing, a quarter-wave plate is arranged between the sample and the polarization camera for changing the polarization of the light, with a principal optical axis of the quarter-wave plate that is rotated by +/−45° with respect to a light plane, which is configured such that it converts specific linear polarization orientations of the light into circular polarization orientations, and the ellipsometer is configured to calculate a layer-thickness-dependent ratio of the detected light intensities using the equations RZ=(I_{R}−I_{L})/(I_{R}+I_{L}) and R45=(I₄₅−I₋₄₅)/(I₄₅+I₋₄₅). I_{R} is an intensity of light in the right circular polarization orientation, I_{L} is an intensity of light in the left circular polarization orientation, I₄₅ is an intensity of light in the 45° linear polarization orientation, and I₋₄₅ is an intensity of light in the 135° linear polarization orientation.

In other words, the polarization camera of the imaging ellipsometer has a large number of differently rotated linear polarization filters, which are integrated in the system at the sensor level of the polarization camera. In particular, the polarization camera is executed as a polarization 2D camera, but can also be designed as a polarization 1D camera for special applications. The ellipsometer has a light source that generates a light beam, which is converted by a polarizer into a linearly/parallel polarized light, i.e. into light with an electric field that is only in one plane, e.g. at a 45° angle to the (light) plane formed by the illumination axis and the lens axis. The polarized light, whose light beam is rotated in a polarization direction of, for example, 45° to the light plane, strikes a preferably cylindrical sample whose layer thickness is to be measured, and is reflected by it. The reflected light then passes through an angle-selective lens and strikes the polarization camera with the corresponding polarization filters. According to the invention, the polarization filters of the polarization camera are arranged with or in rotational positions/alignments/arrangements of 0°, 45°, 90° and 135° or −45° in a defined pattern of parallel filter structures, which polarize the polarized light into the respective polarization orientations or specifically block the polarized light components. For example, the pixel field of the polarization camera is divided into groups of four, in particular into 2×2 arrangements, over the entire pixel array and the polarization camera carries out measurements of the intensities of the respective linear polarizations with the orientations of 0°, 45°, 90° and 135° via the (pixel) groups of four. With the help of a telecentric lens, the sample to be measured or the object to be imaged is captured by the polarization camera without perspective distortion. The sample is preferably imaged using an angle-selective lens, i.e. with a small acceptance angle, so that only a very narrow cone of light is imaged from each object point. On the one hand, this defines a defined angle of reflection for each object point, which is important for an exact ellipsometric measurement. On the other hand, the angular selectivity in transparent cylindrical samples allows for separate imaging of the inner and outer wall reflections. Furthermore, angular selectivity also signifies a large depth of field, so that even very long tilted objects can be imaged with sufficient sharpness over the entire object length. Angular selectivity is achieved primarily by using pinhole apertures within the lens. Angle-selective lenses are often telecentric on the lens side, i.e. only rays that enter the lens parallel to each other and parallel to the optical axis are imaged. In the present invention, this has the additional advantage that the angle of reflection of the captured reflected rays is constant over the entire object length.

Alternatively, a constant angle of incidence and angle of reflection can also be achieved by means of good parallel collimation of the incident light. If the sample is also essentially specularly reflective, the well-defined angle of incidence resulting from the collimation also results in a well-defined fixed angle of reflection. In this case, the lens can be of a more general nature and does not have to be telecentric, and only needs angular selectivity if the other properties mentioned above are advantageous.

For large samples, a correspondingly large aperture of the imaging optics is necessary for parallel beam guidance. To avoid the high costs associated with this, it is advantageous to choose convergent beam guidance instead of parallel beam guidance. In this case, the light source is configured in such a way, e.g. by appropriately positioning a focusing lens in front of a punctiform source, that the light rays converge onto the sample, or at least have a significant portion of such convergent light. After reflection from the sample, the relevant light rays converge again and can be imaged onto the polarization camera by a comparatively small, inexpensive lens.

To restrict the light cone captured from each object point, the object can additionally be configured so as to be angle-selective. This is achieved, for example, by a suitably positioned pinhole aperture within the lens.

If the sample is cylindrical and the cylinder axis is in the light plane, a convergent beam guidance signifies a variable angle of incidence/reflection over the cylinder length. This non-constant angle of incidence/reflection accordingly then has to be taken account of in the evaluation. The angle of incidence/reflection is important for the evaluation and, according to the invention, is typically chosen so that it is equal to or in the range of a Brewster angle of the substrate.

If the cylinder axis is normal to the light plane, the angle of incidence/reflection is advantageously constant. However, in this case, the illuminating beam of light must have a much larger cross-section so that either correspondingly large exit apertures of the light source are required or the light source is composed of several emitters that together generate convergent illumination on the sample such that the reflected light can be imaged onto the polarization camera by a comparatively small lens.

Conversion to circular polarization orientations only occurs for light beams with linear polarization orientations whose alignment is +/−45° to a main axis of the quarter-wave plate. Light beams with a linear polarization orientation of 0° or 90° to the main axis of the quarter-wave plate are not changed, whereas the light beams with the remaining polarization orientations are converted into elliptical polarization orientations. The reference plane for the definition of the polarization state can be, for example, the light plane defined by a central incident beam and a central beam reflected from the sample.

By using an ellipsometer that has only one polarization camera to measure the layer thickness of a sample, the measurement system can be produced at a lower cost due to the relatively small number of components, and it can be handled robustly because different sensitivity fluctuations and faulty polarization measurements are avoided when using several polarization cameras. Accordingly, the areal layer thickness measurements also are carried out at high speed. Furthermore, the pixels are arranged on a common sensor or a common sensor plane, whereby the results of the measurements additionally are more robust.

Advantageous embodiments are subject of the sub-claims and are explained in more detail below.

Further, the quarter-wave plate is arranged in such a way that a main optical axis/crystal optical axis of the quarter-wave plate is rotated by 45° with respect to a light plane.

In other words, the ellipsometer has an additional quarter-wave plate/retardation plate/circular polarizer, in particular made of a birefractive material (e.g. a birefractive plastic), which is arranged, with respect to the direction of the light beam, in front of the sensor plane and the polarization filters of the polarization camera and behind the sample. Thus, the light reflected by the sample, in particular the elliptically polarized light, falls on the quarter-wave plate, the thickness of which is selected so that a phase shift of ¼ wavelength occurs for the polarized light. The light that is elliptically polarized by reflection from the sample correspondingly is polarized differently after passing through the quarter-wave plate. Depending on the desired measurement, the main axis of the quarter-wave plate is rotated by 0° or 45° with respect to a horizontal during operation of the ellipsometer.

In combination with a polarization filter connected downstream, which is turned +/−45° to the main axis of the quarter-wave plate, the intensity of the originally contained right-/left-circularly polarized light can be measured.

If the polarization filter is at a position of 0°/90° to the main axis of the quarter-wave plate, the quarter-wave plate has no effect on a subsequent intensity measurement.

When using a 0°/45°/90°/135° polarization camera, the following applies: in combination with 0°/45°/90°/135° polarization filters located downstream, on or immediately in front of the sensor, the four intensities of the originally included +/−45° linearly polarized light and the right-/left-circularly polarized light can be measured at a +/−45° position of the quarter-wave plate.

Thus, by calculating the corresponding intensity ratios, a measurement of the 3rd and 4th Stokes component of the original polarization state describing the Stokes vector is realized. This is advantageous for measuring the thickness of coatings whose refractive index differs only slightly from the refractive index of the base material.

When the quarter-wave plate is at 0° or 90°, the intensity of the originally contained 0°-/90°-linearly polarized light and the right-/left-circularly polarized light can be measured accordingly. Thus, by calculating the corresponding intensity ratios, a measurement of the 2nd and 4th Stokes component of the Stokes vector describing the polarization state is realized.

Thus, the polarization camera of the ellipsometer is configured and arranged such that, for determining the polarization state of the detected light, it measures at least the second and third Stokes components which are meaningful in particular for layer thickness measurements of samples with strongly differing refractive indices between the coating and the substrate/base body. In the event that an additional quarter-wave plate, in particular at a 45° position, is connected upstream the polarization camera, the polarization camera measures the third and fourth Stokes components of the detected (circularly polarized) light beam to provide simple and robust layer thickness measurement for a sample with similar refractive indices between the coating and the base body.

In another preferred aspect of the invention, the ellipsometer has additional collimating optics/collimator, consisting, for example, of a plurality of spherically shaped lenses and/or cylindrical lenses for samples with a particularly large aspect ratio or of Fresnel lenses for particularly large samples, which collimator is arranged behind the polarizer with respect to the beam direction and/or between the light source and the sample and which collimates the beams of (linearly) polarized light onto the sample. The cylindrical lenses offer advantages for rapid processing by generating a rectangular beam.

In other words, the light beams linearly polarized by the polarizer pass through an additional collimating optics that collects the beams leaving the polarizer in a divergent manner and directs them onto the sample in such a way that they strike the sample in parallel and in a broad beam. Accordingly, the light originally emitted from a punctiform source is converted into a beam of parallel rays, whereby the light is aligned in a specific direction.

In another preferred aspect of the invention, a sensor or the sensor plane of the polarization camera is disposed at an angle with respect to a light beam incident in the polarization camera.

Accordingly, the polarization camera or only its sensor plane is arranged opposite the sample to be measured such that the light beam reflected by the sample falls onto the sensor plane at an angle. This tilting of the image/sensor plane of the polarization camera vis-à-vis the object plane, according to the Scheimpflug condition, is to be created such that these planes intersect and their intersection lines fall in the lens plane. In other words, the tilting of the sensor plane causes the object, lens and sensor planes to intersect in a common line. This ensures that an oblique object plane can always be imaged sharply by the polarization camera.

Moreover, the invention relates to a method using an imaging ellipsometer, in particular as described above, with a monochromatic light source, a polarizer, an angle-selective lens and a polarization camera for areal layer thickness measurement of a, preferably cylindrical, sample. The method comprises the steps of illuminating the sample by means of light emitted by the light source and subsequently linearly polarized by the polarizer and detecting the light reflected by the sample, and imaging the sample in an angle-selective manner onto a sensor plane of the polarization camera through the lens. Preferably, the polarized light beam is collimated by collimating optics before it hits the sample. According to the invention the method uses the steps of polarizing the detected light into linear polarization orientations/polarization directions of 0°, 45°, 90° and 135° or −45° by segmented polarization filters of the polarization camera, converting the light polarized by the polarizer and the sample using a quarter-wave plate whose optical main axis is turned by +/−45° with respect to a light plane, whereby in place of the intensities of the light in the polarization orientations 0° and 90°, an intensity of a right-handed circular polarization orientation and an intensity of a left-handed circular polarization orientation are measured by the polarization camera, measuring the intensities of the light in the respective polarization orientations by the polarization camera, calculating at least a layer-thickness-dependent ratio from the measured intensities of the different polarization orientations by equations RZ=(I_{R}−I_{L})/(I_{R}+I_{L}) as a circular (measurement) signal and R45 = (I₄₅−I₋₄₅)/(I₄₅+I₋₄₅) as a linear (measurement) signal, where I_{R} is an intensity of light in the right-hand circular polarization orientation, I_{L} is an intensity of light in the left-hand circular polarization orientation, I₄₅ is an intensity of the light in the linear 45° polarization orientation and I₋₄₅ is an intensity of the light in the linear 135° polarization orientation, and evaluating the at least one ratio and calculating a local layer thickness of the sample. Optionally, the reflected light beam strikes an obliquely arranged sensor plane of the polarization camera, ensuring a sharp representation of the possibly obliquely/inclined object plane of the sample. Any possible coating on the sample influences the reflection properties of the light, causing a new polarization state of the reflected light, which in turn influences the intensity ratio measured by the polarization camera. These calculated intensity ratios are correlated/compared with the sought-after layer thickness or other layer properties of the measured sample using mathematical modeling.

Additionally or alternatively, the light polarized by the polarizer is converted using a quarter-wave plate whose optical main axis is turned by 0° or 90° with respect to the light plane, whereby in place of the intensities of the light in the polarization orientations 45° and 135°, an intensity of a right-hand circular polarization orientation and an intensity of a left-hand circular polarization orientation are measured by the polarization camera.

For example, further layer-thickness-dependent intensity ratios can be calculated as a function of measured light intensities of the polarization orientations 0° or p-polarization and 90° or s-polarization. For example, measurement signals can be calculated from the intensity ratios Rps=Iₚ/Iₛ and/or Rps2=(Iₚ−Iₛ)/(Iₚ+Iₛ). In this equation, Iₚ is the measured/detected intensity of the p-polarization proportion of the light beam and Iₛ is the measured/detected intensity of the s-polarization proportion of the light beam. The p-polarization is polarized parallel to the light plane and the s-polarization is perpendicular to it, whereby, when, according to the invention, the polarization camera is set up with its 0° filter direction parallel to the p- or s-polarization, the intensities Iₚ and Iₛ correspond to the intensities I₀ and I₉₀ measured by the polarization camera.

Tilting the camera is generally easier, but it worsens the effect of the polarization filters integrated in the camera sensor, since the light then falls obliquely onto the sensor. This problem can be avoided by alternatively tilting the lens elements of the objective.

In a further aspect of the invention, the sample is a cylinder with a layer thickness to be measured and a cylinder axis that is rotated by 0° or 90° vis-à-vis the light plane. Accordingly, the light emitted by the light source and then polarized by the polarizer radiates parallel or normal to the cylinder axis of the sample. This means that a corresponding line can be imaged along the cylinder parallel to the cylinder axis, preferably using an angle-selective, possibly object-side telecentric optics. In particular, the measurement of a cylindrical sample with a cylinder axis in the 0° position with respect to the light plane is carried out under the Scheimpflug condition.

In other words, the sample is a cylinder, or locally cylindrical in shape, with a layer thickness to be measured. Accordingly, the light emitted by the light source and then polarized by the polarizer and collimated by the collimator, shines onto the sample over a large area. This allows a corresponding line along the cylinder to be imaged parallel to the cylinder axis, preferably by means of an angle-selective object-side telecentric optics, which ensures the definition and constancy of the viewing angle required for ellipsometry. For samples that are smaller than the lens aperture, an angle of 90° between the light plane and the cylinder axis is advantageous, since a sharp image is then obtained over the entire length of the sample. For samples that are larger than the lens aperture, an angle of 0° between the light plane and the cylinder axis is advantageous. The oblique view makes the probe appear smaller and, despite its size, can be imaged in its entirety at a suitably chosen viewing angle. To achieve a sharp image, the camera and/or the lens can additionally be tilted so that the Scheimpflug condition is at least approximately met.

The use of cylindrical samples allows an evaluation or imaging of lines that make up the cylinder wall. By rotating the samples, the entire sample wall thus can be measured or imaged. The corresponding measurement along a respective line provides for a qualitative conformity with conventional measuring methods. Furthermore, defects can be clearly shown/imaged by the correspondingly executable panoramic measurements along the sample walls. In addition, real-time measurements on rotating cylinder samples can be performed easily and with good repeatability.

In a further aspect of the invention, the sample is formed as a transparent, in particular coated, cylinder with a layer thickness to be measured, and a light reflected from an inner side of the sample wall, and a light reflected from an outer side of the sample wall are detected separately by the polarization camera or are detected together in the case of thin-walled transparent cylinders. This separate detection is facilitated or made possible by a small acceptance angle of the objective. In other words, the use of an angle-selective lens is advantageous or necessary for the separate detection of inner and outer wall reflections.

In other words, the beam of light striking a/being directed to a cylindrical (thick-walled) sample with a (cylinder) inner wall side and a (cylinder) outer wall side is reflected partially from the inner wall side and at the same time partially from the outer wall side. By means of sufficiently well collimated illumination and angle-selective and possibly also object-side telecentric optics, an inner side reflection (of the sample wall) can be separated from an outer side reflection (of the sample wall), whereby the polarization camera detects the reflected light rays separately and evaluates them separately from each other. In particular, the reflected light beams are acquired using an angle-selective lens, which makes it easy to separate the inner and outer reflections. Regarding the thickness of the wall, it should be added that it is a prerequisite for the separability of the two reflections. This is not the case with PET bottles, for example, and the reflected light contains both reflections at the same time. In this case, the reflections of the outer and inner sides are acquired and evaluated together.

This means that, in addition to the thickness of an outer wall coating of a cylindrical sample, in particular a glass tube/carpule/bottle, also the thickness of an inner wall coating of the same sample can be measured and evaluated, respectively, at the same time in a single measuring sequence.

Moreover, the distance between the image of the inner wall reflection and the image of the outer wall reflection is a measure of the wall thickness of the cylinder. Thus, in addition to the layer thickness measurement, a wall thickness measurement can also be realized.

Alternatively, the ellipsometer according to the invention can be used in a roll-to-roll/roll-to-roll/R2R process in which a substrate that can be rolled off a roller, for example a flexible plastic or metal film, is printed. In particular, the flexible films in this process are printed with flexible electronics/flexible electronic components, e.g. with photovoltaic components. In this process, a deflection roller, on which the film/substrate with the additional printed layer is rolled off or deflected, is illuminated directly with a 45°-polarized and preferably collimated light beam. The polarization camera is arranged, preferably obliquely with respect to the axis of the deflection roller, so that a reflection of the light beam along a line on this film sample can be acquired by the polarization camera. Well-collimated illumination of the film as well as the angle-selective optics of the ellipsometer ensure that the reflected light beams are properly acquired. These R2R measurements can be performed in a narrow-band manner (bandwidth smaller than the diameter of the lens aperture) on the deflection roller, in orientation normal to the roller axis (90° angle between the light plane and the axis of the deflection roller), or also in a broadband manner on the deflection roller, in an orientation parallel to the roller axis (0° angle between the light plane and the axis of the deflection roller). This layer thickness measurement, which is carried out directly on the deflection roller of the R2R process, enables a high degree of stability against film vibrations and also suppression of any backside reflections that may occur through the use of a suitable deflection roller. Furthermore, this makes it possible to measure the layer thickness in real time during the actual R2R process, i.e. immediately after the actual coating process. The measurement is therefore carried out advantageously on a deflection roller, on which the film is rolled or deflected, and thus on a cylindrical surface.

In another preferred aspect of the invention, the polarization camera detects and evaluates one or more additional reflections of the light beam from a rear wall of the sample that is located furthest away from the polarization camera. In thick-walled samples, such evaluable reflections are at the front and back of the rear wall of the sample, making it appear valuable to focus an evaluation on them. A certain analogy to the front wall in behavior can be determined.

In other words, in addition to a first reflection of the light beam from the sample, which originates from the sample wall that is closer to the polarization camera, a further reflection of the light beam from the rear wall of the sample, i.e. the sample wall that is farther away from the polarization camera, can also be acquired and evaluated. This provides a measurement for each sample/container along two opposing lines of the cylindrical sample, which run along the sample parallel to the cylinder axis.

In a further aspect of the invention, the polarization camera detects the light reflected from the sample during a rotational movement of the sample.

In a further aspect of the invention, the cylindrical sample is illuminated with collimated light from various, slightly different directions. This can be achieved by prisms and/or mirrors in combination with the collimator so that only one light source continues to be necessary. Thus, more lines on the circumference can be imaged onto the sensor at the same time and thus also evaluated simultaneously, making better use of the sensor area and thus also gaining more information about the uniform distribution of the coating.

In another aspect of the invention, the cylindrical sample can also be illuminated with slightly convergent light, making the imaged line wider so that more information about the uniform distribution of the coating can be obtained from a single image.

Thus, a large number of measurements can be carried out successively at different densities or at different distances from one another, depending on the accuracy and resolution requirements, without the respective components of the imaging ellipsometer having to be moved. Only the sample to be measured is rotated during the measuring processes, which additionally reduces the complexity and the number of components of the measuring system. For example, if the layer thickness measurements are carried out on a single bottle or carpule it is placed on a rotatable device during the measuring processes, or in case these measurements are carried out on a large number of bottles or carpules in a production line, this large number of bottles or carpules is arranged within or attached to a conveyor system that moves the multiple bottles or carpules past the statically arranged polarization camera. Thus, layer thickness measurements on a plurality of samples can be carried out quickly and efficiently, without time-consuming changing/exchanging of samples. This real-time measurement/panoramic measurement on the rotating carousel device, for example at 10 measurements per second, clearly indicates missing coatings with a high degree of repeatability.

The invention and the technical environment will be explained in more detail below on the basis of the figures. It should be noted that the invention is not to be restricted by the examples shown. In particular, unless explicitly stated otherwise, it is also possible to extract partial aspects of the facts explained in the figures and to combine them with other components and findings from the present description and/or figures. In particular, it is to be pointed out to the fact that the figures, and in particular the proportions shown, are only schematic. Identical features are provided with identical reference signs. Furthermore, it is pointed out to the fact that the features of the individual embodiments can be interchanged and can occur in a specific combination.

### BRIEF DESCRIPTION OF THE DRAWINGS

The present invention and one of the advantageous embodiments are described below with reference to the figures. The figures are only schematic in nature and only serve to aid understanding of the invention.

FIG. 1 is a schematic representation in a plan view of the ellipsometer according to the invention in accordance with an advantageous embodiment,

FIG. 2 is a schematic sectional view through the axis of a cylindrical sample to be measured during a measuring process,

FIG. 3 shows an exemplary diagram showing the measured areal layer thickness profiles of an internally coated carpule with defects during a panoramic measurement,

FIG. 4 shows an exemplary diagram showing the measured areal layer thickness profiles of internally coated (PET) bottles during a panoramic measurement.

Identical features are provided with identical reference signs.

### DETAILED DESCRIPTION OF VARIOUS EMBODIMENTS

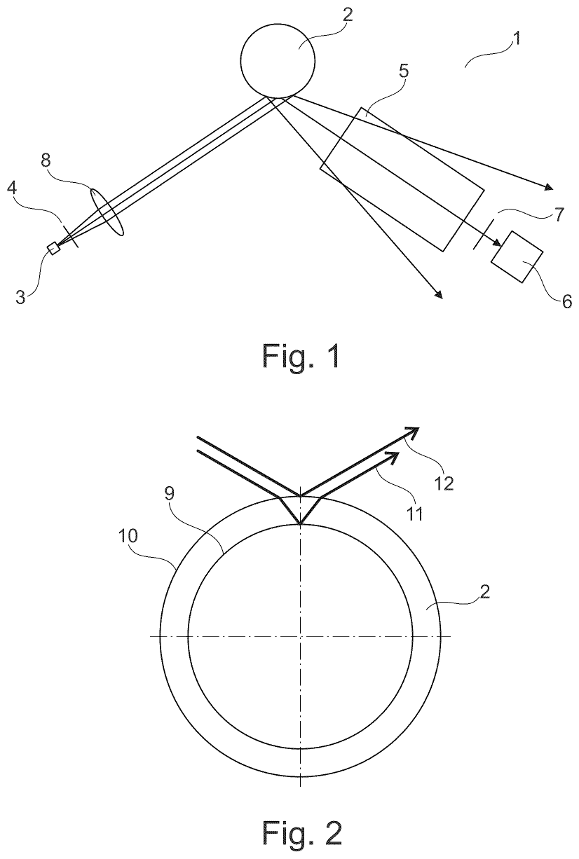

FIG. 1 shows a plan view of the ellipsometer 1 according to the invention in accordance with an advantageous embodiment. Another spatial arrangement is possible and may be preferred depending on the application.

The ellipsometer 1 has a light source 3, the emitted light beams of which pass through a polarizer 4 with a polarizer axis that forms a 45° angle with the drawing plane. The light beams linearly polarized by polarizer 4, then pass through a collimating optic 8, optionally consisting of cylindrical lenses, whereby the beams are collimated and incident on a cylindrical sample 2 to be measured. The incident beams are then reflected by the sample 2 and possibly also are scattered, resulting in a highly divergent reflection with a wide beam diameter. A portion of the wide beam is detected by an angle-selective and possibly object-side telecentric lens 5 and then passes through a quarter-wave plate 7 whose main axis in this illustrated embodiment forms a 45° angle with the drawing plane. The reflected polarized light beams are then acquired by a polarization camera 6 with polarization filters in 0°, 45°, 90° and 135° orientations. The polarization filters polarize the detected light in the polarization directions 0°, 45°, 90° and 135° and the following sensor measures the respective intensities of these proportions. At least one layer thickness-dependent ratio is then calculated from the measured intensities and evaluated, resulting in a local layer thickness of sample 2.

FIG. 2 shows a sectional view through the cylinder axis of a cylindrical sample 2 to be measured during a (layer thickness) measuring process. The thick-walled sample 2 has an inner wall side 9 and an outer wall side 10. Furthermore, collimated, 45° linearly polarized light beams are imaged that hit the sample 2. Only those beams are shown that after reflection by sample 2 hit the (angle-selective) lens not shown in parallel. The light beam 12 reflected by the outer wall side 10 of sample 2 and the light beam 11 reflected by the inner wall side 9 of sample 2 likewise run parallel to each other. Recognizable are equal angles of incidence and reflection of the light beams on and from sample 2, respectively. Furthermore, a refraction of the beam within the sample wall, which passes through the wall of sample 2 and is reflected by the inner wall side 9, is to be seen. Thus, light beams of internal reflection and external reflection can be acquired in a well-separated manner. Furthermore, in case of a sufficiently wide beam of light that hits sample 2, also additional light beams that are reflected by the inner wall side 9 and outer wall side 10 of the sample 2 can be detected by the lens on points (herein: below) that are opposite the reflection points shown in this figure (herein: above) from the inside 9 and outside 10 of the sample 2 at the points (here below).

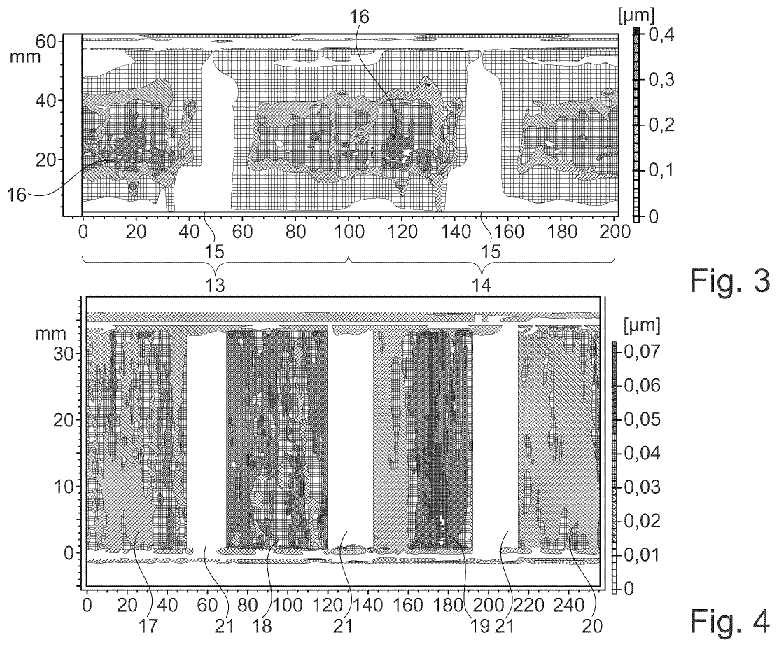

FIG. 3 shows an exemplary diagram of the measured areal layer thickness profiles of a silicone oil-coated carpule with defects 15 during a 20-second panoramic measurement. The x-axis of the diagram shows a number of measurements between 0 and 200, whereas the y-axis represents a height section of the sample between 0 and 60 mm. The measurements are carried out during a rotational movement of the carpule, with 100 measurements being performed per revolution. The measured layer thicknesses of the carpule are shown using variably dense hatching. The layer thicknesses range from 0 μm (no hatching) to 0.4 μm (strong or dense hatching). The diagram is divided along the x-axis into an area of the first revolution 13 of the carpule and an area of the second revolution 14 of the carpule, each showing 100 measurements by the ellipsometer according to the invention, thus composing an areal layer thickness profile of the carpule. Recognizable is an area of high layer thickness 16, which occurs in the first half of the respective revolutions of the carpule. Moreover, a defect 15 is shown, approximately at measurements 40 to 60 and 140 to 160, which was created prior to these measurements by pushing through a cotton swab.

FIG. 4 shows an exemplary diagram of the measured areal layer thickness profiles of four differently coated (PET) bottles, for example with a coating in the form of a barrier layer of SiO₂ on the inside, during a panoramic measurement. The x-axis of the diagram shows the number of measurements between 0 and 255, whereas the y-axis represents a height section of the samples between 0 and about 35 mm. Measurements are only performed in one label area of the bottles. Each of the four differently coated bottles undergoes 50 measurements per revolution, which are shown in this diagram as (measuring) ranges 17, 18, 19 and 20. Between each measurement of the coated bottles, a range of approx. 20 measurements on a further uncoated bottle is shown. The (measuring) ranges 21 on the uncoated bottle are not hatched, whereas the hatching(s) is/are displayed more densely with increasing layer thickness of the labels of the coated bottles. Layer thicknesses of between 0 and 0.07 μm are shown. Recognizable are the comparatively high layer thicknesses of up to 0.07 μm of the second and third coated bottles in the illustrated (measuring) ranges 18 and 19.

### LIST OF REFERENCE SIGNS

1 Ellipsometer
2 Sample
3 Light source
4 Polarizer
5 Angle-selective lens, possibly telecentric on the object side
6 Polarization camera
7 Quarter-wave plate
8 Collimating optics
9 Inner wall side (of sample)
10 Outer wall side (of sample)
11, 12 Reflected light
13 Area of the first revolution
14 Area of the second revolution
15 Defect
16 Area of high layer thickness
17 (Measuring) Range of the first coated bottle
18 (Measuring) Range of the second coated bottle
19 (Measuring) Range of the third coated bottle
20 (Measuring) Range of the fourth coated bottle
21 (Measuring) Range of the uncoated bottle

1-10. (canceled)

11. An imaging ellipsometer for areal layer thickness measurement of a sample, the imaging ellipsometer comprising:
a monochromatic light source configured to shine light onto the sample,
a polarizer configured to linearly polarize the light emitted by the light source,
an angle-selective lens, wherein the light reflected by the sample passes through the angle-selective lens, and
a polarization camera, onto which the light reflected by the sample strikes,
wherein the polarization camera having polarization filters in 0°, 45°, 90° and 135° orientations and being adapted to polarize the light emitted from the light source into linear polarization orientations and to detect and measure the light intensities thereof,
wherein a quarter-wave plate is arranged between the sample and the polarization camera to change the polarization of the light, with a principal optical axis of the quarter-wave plate that is rotated by +/−45° with respect to a light plane, which is configured to convert certain linear polarization orientations of the light into circular polarization orientations and the ellipsometer is adapted to calculate a layer-thickness-dependent ratio of the detected light intensities using equations
$$RZ = ( IR - IL ) / ( IR + IL ) \\ and \\ R 45 = ( I 45 - I - 45 ) / ( I 45 + I - 45 ) ,$$
where IR is an intensity of light in the right-hand circular polarization orientation, IL is an intensity of light in the left-hand circular polarization orientation, I45 is an intensity of light in the linear 45° polarization orientation, and I−45 is an intensity of light in the linear 135° polarization orientation.

12. The imaging ellipsometer according to claim 11, wherein a collimating optical system, optionally comprising cylindrical lenses, which is disposed behind the polarizer and/or between the light source and the sample and collimates the beams of polarized light onto the sample.

13. The imaging ellipsometer according to claim 11, wherein a sensor plane of the polarization camera is located at an angle with respect to a light beam incident in the polarization camera.

14. A method using an imaging ellipsometer with a monochromatic light source, a polarizer, an angle-selective lens, and a polarization camera for areal layer thickness measurement of a sample, comprising the steps of:
illuminating the sample with the aid of light emitted from the light source and subsequently linearly polarized by the polarizer;
detecting the light reflected by the sample and imaging the sample onto a sensor plane of the polarization camera through the angle-selective lens;
linearly polarizing the detected light in linear polarization orientations of 0°, 45°, 90° and 135° by segmented polarization filters in the polarization camera;
converting the light polarized by the polarizer and the sample with the aid of a quarter-wave plate, whose main optical axis is rotated by +/−45° with respect to a light plane, wherein, instead of the intensities of the light in the polarization orientations 0° and 90°, an intensity of a right-hand circular polarization orientation and an intensity of a left-hand circular polarization orientation are measured by the polarization camera;
measuring the intensities of the linearly polarized light in the respective polarization orientations by the polarization camera;
calculating at least one layer-thickness-dependent ratio from the measured intensities of the various polarization orientations by means of equations
$$RZ = ( IR - IL ) / ( IR + IL ) \\ and \\ R 45 = ( I 45 - I - 45 ) / ( I 45 + I - 45 ) ,$$
where IR is an intensity of light in the right-hand circular polarization orientation, IL is an intensity of light in the left-hand circular polarization orientation, I45 is an intensity of light in the linear 45° polarization orientation, and I−45 is an intensity of light in the linear 135° polarization orientation; and
evaluating said at least one ratio and calculating a local layer thickness of the sample.

15. The method according to claim 14, wherein the sample is a cylinder with a layer thickness to be measured and a cylinder axis which is rotated by 0° or 90° with respect to the light plane,
wherein the light emitted by the light source and subsequently polarized by the polarizer shines parallel or normal onto the cylinder axis of the sample.

16. The method according to claim 15, wherein the sample is a transparent cylinder having a layer thickness to be measured,
wherein light reflected from an inner wall side of the sample and light reflected from an outer wall side of the sample is detected separately by the polarization camera or, in the case of thin-walled transparent cylinders, is detected together.

17. The method according to claim 14, wherein the sample is a flexible film, the measurement being carried out on a deflection roller, on which the film is rolled or deflected, on a cylindrical surface.

18. The method according to claim 16, wherein the polarization camera acquires and evaluates additional reflection or a plurality of additional reflections of the light beam from a rear wall of the sample which is arranged farthest away with respect to the polarization camera.

19. The method according to claim 14, wherein the detection of the light reflected by the sample by the polarization camera takes place during a rotational movement of the sample.
